(19) United States
(12) Patent Application Publication
(10) Pub. No.: US 2015/0010725 A1
(43) Pub. Date: Jan. 8, 2015

(54) Label Roll Including an Electronic Element

(71) Applicant: Identive Group, Inc., Santa Ana, CA (US)

(72) Inventors: Werner Vogt, Remetschwil (CH); Michael Kober, Bruckmuehl (DE)

(73) Assignee: Identive Group, Inc, Santa Ana, CA (US)

(21) Appl. No.: 13/934,868

(22) Filed: Jul. 3, 2013

(51) Int. Cl. G09F 3/00

(52) U.S. Cl. CPC G09F 3/0286
USPC 428/43; 428/80

(57) ABSTRACT

Described herein is a label roll comprising a liner and a plurality of labels affixed to the liner, wherein each edge of a first label that neighbors another label in a release direction of the label roll comprises (i) at least one protuberance that engages with a recess in an edge of the other label or (ii) at least one recess that is engaged by a protuberance in an edge of the other label.

### TECHNICAL FIELD

The subject matter of the application relates generally to a label roll, including a label roll with an electronic element.

### BACKGROUND

As the use of plastic cards for credit cards, identification cards and the like continues to become more widespread, credit card fraud and identification card fraud are becoming increasing problems. The ease in which criminals have been able to manufacture or manipulate current cards is a result of the existence of the easily-altered magnetic stripe storage medium used by current cards. These magnetic stripes are easy to program and reprogram using commonly available technology, resulting, e.g., in so-called magnetic stripe cloning.

Thus, there is a need in the plastic card industry to provide a more secure plastic card that is more difficult or nearly impossible to duplicate or manipulate. The likely successor to the magnetic stripe cards is known as a memory card or smart card. The smart card can generally be described as a card having an integrated circuit with memory that is capable of securely storing data and/or executing processing functions.

Contact smart cards make contact through several contact pads place on the surface of the card. These pads provide electrical connectivity when inserted into a reader, which is typically used as a communications medium between the smart card and a host. Cards typically do not contain batteries—power is supplied by the card reader—through some of these contact pads.

The most recent development in smart cards is a contactless card that interacts with a terminal reader using electromagnetic coupling. The smart card incorporates an inlay that is a symmetrical substrate incorporating a micro-chip bounded to an antenna and functioning as the heart of a radio-frequency identification (RFID) part, a near field communication (NFC) chip, or similar chip credential. This smart card requires only proximity to a reader antenna to communicate. Contactless cards also typically operate without batteries and obtain power through induction from the electromagnetic field of the reader antenna. When in proximity to a reader antenna, they accumulate charge from the electromagnetic field, power up and consequently respond to commands over the same radio frequency channel, communicating in a bi-directional manner. Contactless technology is rapidly replacing traditional machine readable identification technologies in numerous applications such as those employing bar codes and magnetic stripes, offering substantially enhanced security and convenience.

Self-adhesive smart card labels are a special type of smart card for easily adding contactless smart card technology to another type of device or form factor (e.g., a key fob, a mobile phone or a PDA). The labels contain a RFID or NFC chip and antenna and allow a user to encode and read them like a smart card. The labels are available in various shapes and sizes and may be used for access control, time and attendance, membership/loyalty programs, logical access, storage of biometric templates, parking, electronic purse, and many other applications requiring secure and reliable read/write cards.

Like other labels, smart card labels are typically provided on label rolls. Such label rolls comprise a liner carrying the labels. When unrolling the label roll, to print the labels for example, the liner is guided by a thin printer roller. While this technique is well established for standard paper labels, smart card labels cause problems when printed using a conventional label printer. Because typical smart card labels have a thickness of about 300 μm or greater and the thin printer roller typically has a radius of below 300 μm, the thin printer roller may be caught between two labels. FIG. 1 and FIG. 2 show a conventional label roll 1 comprising a liner 11 with labels 12a, 12b. If the labels 12a, 12b are smart card labels, the thin printer roller 2 may be caught between the labels 12a, 12b when unrolling the label roll in the direction marked with arrow 6. This stops the printing process since further unrolling of the label roll is blocked.

### SUMMARY

Therefore, what it is needed is a label roll that may be unrolled through a printing device including a thin printer roller, even if the radius of the thin printer roller is equal to or smaller than the thickness of a label provided on the label roll.

The above objective is achieved by the label roll described herein comprising a liner and labels affixed to the liner, where each edge of a label that neighbors another label in a release direction of the label roll comprises at least one protuberance that engages with a recess in an edge of that other label and/or at least one recess that is engaged by a protuberance in an edge of the adjacent label. The engagement of protuberances and recesses of the labels of the label roll causes a thin printer roller of a printing device that guides the liner of the label rolls to the printing device to always rest on the surface of both neighboring labels on passing from one label to another, thereby preventing the thin printer roller from being caught between two labels.

In some embodiments, each edge of a label that neighbors another label in a release direction of the label roll comprises at least one protuberance that engages with a recess in an edge of that other label and at least one recess that is engaged by a protuberance in edge of the following label. This allows the length of the protuberances and the depth of the recesses to be smaller compared to a label wherein each edge of the label only comprises a protuberance or a recess. Therefore, a smaller part of the label has to be reserved for protuberances and recesses. In some embodiments, each edge of a label that neighbors another label in a release direction of the label roll is wave-shaped to provide protuberances and recesses.

In some embodiments, a distance between the edge of a label and each other label that neighbors that label in a release direction is equal over the whole width of that labels. This allows a thin printer roller to be smoothly moved from the surface of one label to the surface of a neighboring label. In some embodiments, the distance between the edge of a label and each other label that neighbors that label in a release direction is greater than the thickness of the labels. This allows easy separation of the labels from the liner.

In some embodiments, each label has a thickness of at least 300 μm which is a typical thickness of a smart card label.

In some embodiments, at least one label comprises a predefined sticker that may be separated from the label. The sticker can have any shape so that the label roll provides stickers according to the needs of the user. In some embodiments, the sticker does not include any protuberance or recess of an edge of the label. In some embodiments, the surface of the predefined sticker is printed and the border of the printing extends beyond the predefined sticker. Because a conventional liner comprises a release layer on its surface, e.g., a silicon layer, the conventional liner typically does not accept any dye. However, if only the sticker has to be printed and not the complete label, it is possible to print beyond the predefined sticker on the rest of the label to guarantee that the border of the sticker is completely covered with dye without risking that any dye is deposited on the liner, which could result in transporting the dye onto the labels and into a printing device. In some embodiments, the predefined stickers separated from the rest of the label by a cut line to allow easy separation of the sticker from the rest of the label.

In some embodiments, the predefined sticker comprises an electronic element, such as an RFID-chip or an NFC-chip and antenna. In these embodiments, the predefined sticker is a smart card or NFC sticker.

In some embodiments, each label includes at least one cut line that separates at least one protuberance and/or at least one recess from the label. In some embodiments, each cut line extends to the liner, allowing the labels to be easily separated from the label roll.

Other aspects and advantages of the invention will become evident from the following detailed description taken in conjunction with accompanying drawings illustrating the principals of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows an isometric view of a label roll according to the state of the art.

FIG. 2 shows a side view of a label roll according to the state of the art.

FIG. 3 shows an isometric view of a label roll, according to an embodiment of the invention.

FIG. 4 shows a top view of a liner of a label roll carrying two labels, according to an embodiment of the invention.

FIG. 5 shows a top view of a liner of a label roll carrying one label, according to another embodiment of the invention.

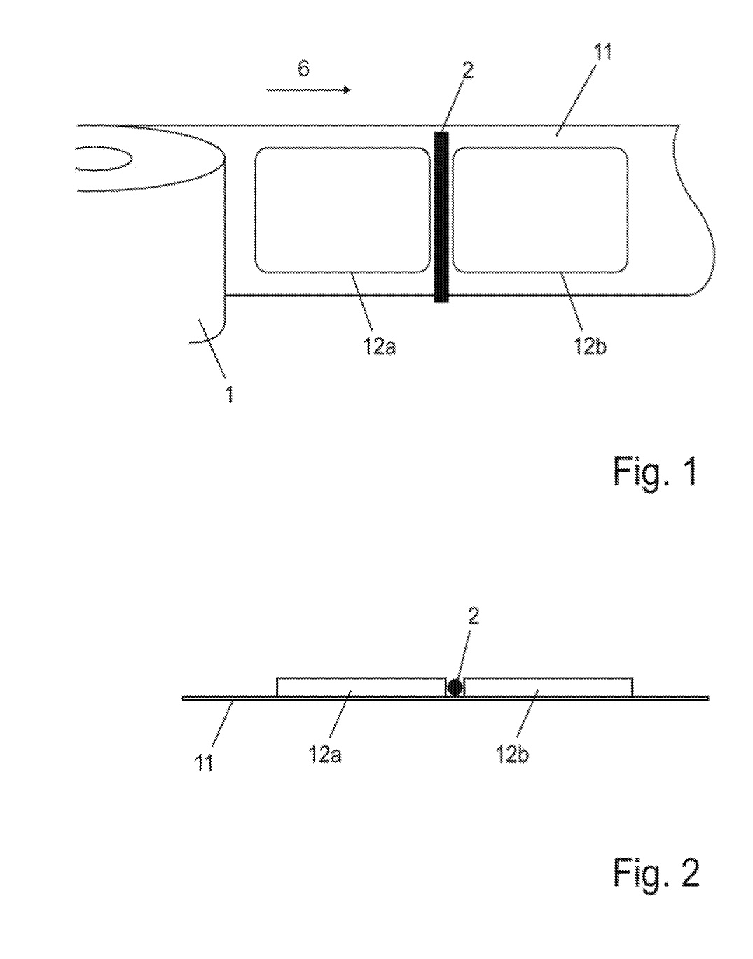

### DETAILED DESCRIPTION

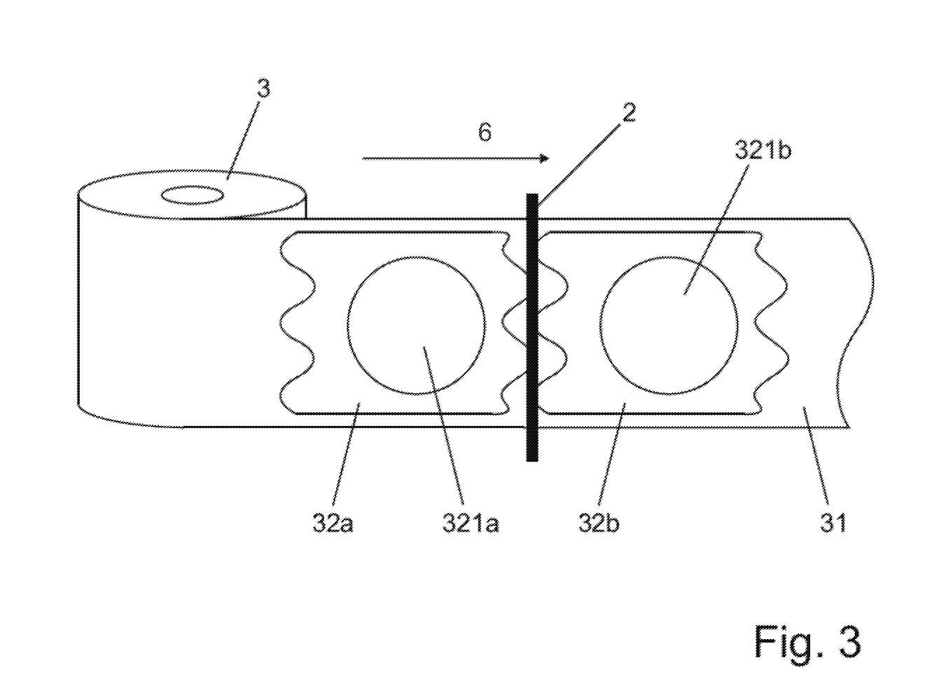

FIG. 3 shows a label roll 3 according to an embodiment of the invention that is partly unrolled in a release direction marked by arrow 6. The label roll 1 includes a liner 31 and two labels 32a, 32b that are adhesively bonded on top of the liner 31. Each label 32a, 32b comprises a circular sticker 321a, 321b. The edge of the first label 32a that neighbors second label 32b in the release direction comprises two protuberances and three recesses. The neighboring edge of the second label 32b comprises three protuberances and two recesses. Each protuberance of one label engages into a recess of the neighboring label. The liner 31 is released into a printing device comprising a thin printer axis roller 2. As can be seen from FIG. 3, the thin printer axis roller 2 is not caught between the two labels 32a, 32b when the label roll 3 is unrolled by moving the liner 31 in the release direction. On passing from the second label 32b to the first label 32a, the thin printer axis roller 2 always rests on the protuberances of at least one of the labels 32a, 32b.

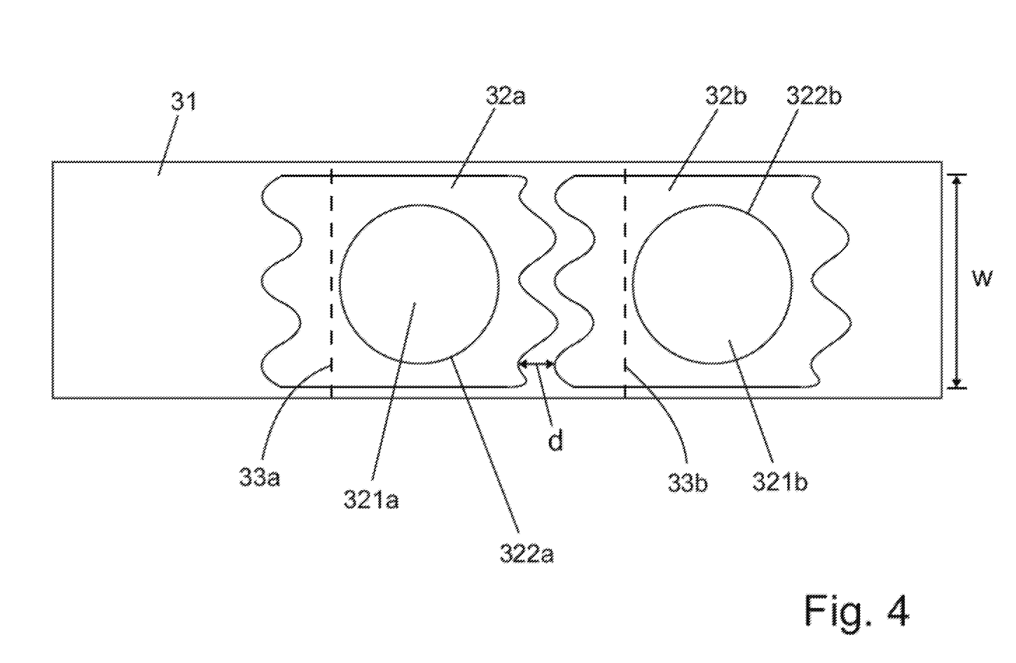

In another embodiment of the invention shown in FIG. 4, two labels 32a, 32b that are arranged on a liner 31 are shown in detail. A distance d between the edge of the first label 32a and the edge of the second label 32b is equal over the whole width w of the labels. Each label 32a, 32b comprises a circular sticker 321a, 321b. Each sticker 321a, 321b is separated from its label 32a, 32b by a circular cut line 322a, 322b. Moreover, each label 32a, 32b includes a cut line 33a, 33b that separates the protuberances and the recesses of one edge of that label 32a, 32b from the rest of the label 32a, 32b. Each of the cut lines 33a, 33b may extend with liner 31.

In another embodiment, each label 32a, 32b includes a cut line 33a, 33b comprised of perforations. In another embodiment, each label 32a, 32b includes a cut line or perforation line 33a, 33b in the form of the wave pattern and located with the gap that separates the protuberances and the recesses of one edge of label 32a from label, 32b. Each of the cut lines or perforations lines 33a, 33b may extend with liner 31.

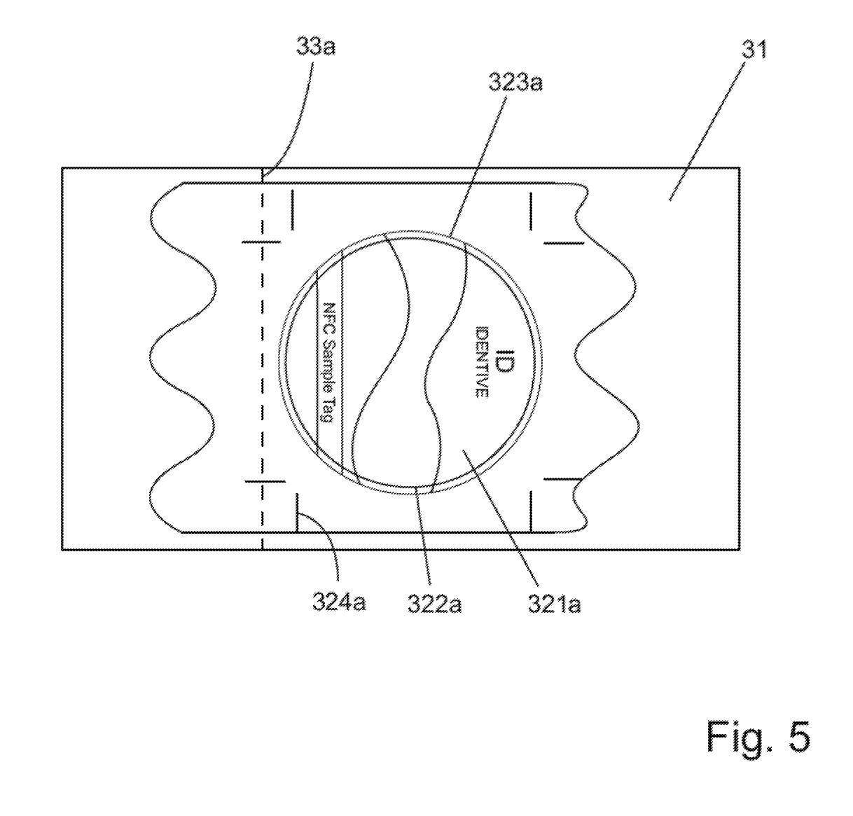

In another embodiment shown in FIG. 5, the sticker 321a of a label 32a is printed. A printing 323a is applied to the label 32a using a printing machine that comprises the thin printer axis roller 2. The printing 323a covers the whole surface of the sticker 321a and extends beyond the circular cut line 322a of the sticker 321a. When the sticker 321a is separated from the rest of the label 32a, no unprinted area of the label 32a remains on the sticker 321a because the sticker 321a is separated from an area that is completely covered by a printing dye. Crop marks 324a may be printed on the label 32a outside of the area that is defined by the circular cut line 322a that separates the sticker 321a from the rest of the label 32a. The sticker 321a is a smart card sticker that comprises an RFID or NFC chip. This results in a thickness of the label 32a of about 300 μm. Due to the wave shape of the edges of the labels 32a, 32b a thin printer axis roller 2 (as shown in FIG. 3) can be moved over the labels 32a, 32b without the risk of being caught between the labels 32a, 32b.

One skilled in the art will realize the invention may be embodied in other specific forms without departing from the spirit or essential characteristics thereof. The foregoing embodiments are therefore to be considered in all respects illustrative rather than limiting of the invention described herein.

1. A label roll comprising:
a liner and
a plurality of labels affixed to the liner,
wherein each edge of a first label that neighbors another label in a release direction of the label roll comprises (i) at least one protuberance that is positioned within a recess in an edge of the other label or (ii) at least one recess within which is positioned a protuberance in an edge of the other label; and
wherein when the label roll is fed through a thin printer axis roller and when the roller moves between edges of consecutive labels on the roll, the roller is supported by the protuberances of the consecutive labels and continuously contacts both the protuberances and an area of the liner that separates the edges of the consecutive labels.

2. (canceled)

3. The label roll of claim 1, wherein each edge of the first label that neighbors the other label in a release direction of the label roll is shaped with an overlapping geometry when viewed on a perpendicular line to the release direction.

4. The label roll of claim 1, wherein the distance between the edge of the first label and the other label that neighbors the first label in a release direction is greater than the thickness of the label.

5. The label roll of claim 1, wherein each label has a thickness of at least 300 μm.

6. The label roll of claim 1, wherein the first label comprises a predefined sticker is separable from the first label.

7. The label roll of claim 6, wherein the surface of the predefined sticker is printed.

8. The label roll of claim 7, wherein the border of the printing extends beyond the boundaries of the predefined sticker.

9. The label roll of claim 6, wherein the predefined sticker is separated from the rest of the label by a cut line.

10. The label roll of claim 6, wherein the predefined sticker includes an electronic element.

11. The label roll of claim 10, wherein the electronic element is a RFID chip or a NFC chip.

12. The label roll of claim 1, wherein each label comprises at least one cut line that separates at least one protuberance and/or at least one recess from the label.

13. The label roll of claim 12, wherein each cut line extends through the liner.
